(19) United States
(12) Patent Application Publication
(10) Pub. No.: US 2017/0251864 A1
(43) Pub. Date: Sep. 7, 2017

(54) Coffee Maker and Control Method Thereof

(71) Applicant: Vesta Electrical Appliance Manufacturing (Zhongshan) Co., Ltd., Zhuhai City (CN)

(72) Inventors: Donglei WANG, Zhuhai City (CN); Xuejun CHEN, Zhuhai City (CN); Dongping LAI, Zhuhai City (CN)

(21) Appl. No.: 15/448,150

(22) Filed: Mar. 2, 2017

(30) Foreign Application Priority Data
Mar. 4, 2016 (CN) 201610125732.2

(51) Int. Cl. A47J 31/42; A47J 31/44; A47J 31/06; A23F 5/26; A47J 31/46

(52) U.S. Cl. CPC A47J 31/42; A23F 5/26; A47J 31/465; A47J 31/0626; A47J 31/4403

(57) ABSTRACT

Provided is a coffee maker, comprising a shell body, a brewing assembly, a slight pressure assembly, a heating assembly and a filtering assembly; the brewing assembly comprises a brewing vessel installed on the shell body; the brewing vessel has a hollow accommodation chamber, which accommodates stuff to be brewed; the slight pressure assembly comprises a booster pump and a pressure pipe; the booster pump is connected with the pressure pipe; the pressure pipe is in communication with the accommodation chamber; the booster pump is configured to supply slight pressure to the brewing vessel; the heating assembly is in communication with the accommodation chamber assembly, and is configured to supply heated water to the brewing vessel; and the filtering assembly is provided on a lower part of the brewing vessel and is in communication with the accommodation chamber. A control method of the coffee maker is further provided.

### CROSS REFERENCE TO RELATED APPLICATIONS

This application claims the benefit of the priority of Chinese Patent Application No. 201610125732.2 filed on Mar. 4, 2016, entitled “Coffee Maker and Control Method Thereof”,

the entire contents of which are incorporated herein by reference.

### TECHNICAL FIELD

The present disclosure relates to technical filed of coffee brewing, and more particularly, to a coffee maker and a control method thereof.

### BACKGROUND OF THE INVENTION

As for the coffee maker in the prior art, coffee making is normally performed by soaking coffee powder with hot water, then making coffee liquid by the natural dripping method. There exist problems of insufficient dissolution of coffee powder and long time of brewing coffee for users.

### SUMMARY OF THE INVENTION

In view of the problems of insufficient dissolution of coffee powder and long time of brewing coffee existing in the coffee maker in the prior art, the present disclosure is to provide a coffee maker, which is capable of ensuring sufficient dissolution of coffee powder and is convenient for users to use. Also, the present disclosure provides a control method for the coffee maker above.

The objective above is realized by the technical schemes as follows:

A coffee maker comprises a shell body, a brewing assembly, a slight pressure assembly, a heating assembly and a filtering assembly;

the brewing assembly comprises a brewing vessel; the brewing vessel is installed on the shell body; the brewing vessel has a hollow accommodation chamber, which accommodates stuff to be brewed;

the slight pressure assembly is installed in the shell body; the slight pressure assembly comprises a booster pump and a pressure pipe; the booster pump is connected with the pressure pipe; the pressure pipe is in communication with the accommodation chamber; the booster pump is configured to supply slight pressure to the brewing vessel;

the heating assembly is installed in the shell body and is in communication with the accommodation chamber; the heating assembly is configured to heated water to the brewing vessel; and

the filtering assembly is installed on a lower part of the brewing vessel and is in communication with the accommodation chamber.

In one of the embodiments, the coffee maker further comprises a control assembly; wherein, the control assembly comprises a control panel and a control board;

the control panel is disposed on the shell body; the control board is disposed in the shell body; the control board is electrically connected with the control panel;

the control board is electrically connected with the brewing assembly; the control board is electrically connected with the heating assembly; the control board is electrically connected with the slight pressure assembly;

In one of the embodiments, pressure supplied to the accommodation chamber by the booster pump is less than 0.4 MPa.

In one of the embodiments, the brewing vessel is further provided with a powder inlet, a water inlet and an air outlet;

the water inlet is in communication with the heating assembly;

the powder inlet, the water inlet and the air outlet are all in communication with the accommodation chamber.

In one of the embodiments, the brewing assembly further comprises a transmission mechanism and a chamber-top seal;

the transmission mechanism is disposed on the chamber-top seal; the transmission mechanism is configures to drive the chamber-top seal to seal the powder inlet, the water inlet and the air outlet.

In one of the embodiments, the brewing assembly further comprises a fast clamp;

the fast clamp has a handle and a clamping part; the handle is arranged on the clamping part; the filtering assembly is connected to the brewing vessel through the clamping part; when the handle rotates to a preset position, the clamping part clamps the filtering assembly and the brewing vessel to make the filtering assembly fixed and sealed.

In one of the embodiments, the filtering assembly comprises a filter and a filtering cup; the filtering cup has a liquid outlet;

the filter is installed in the filtering cup; the filtering cup is installed on the brewing vessel and is in communication with the accommodation chamber.

In one of the embodiments, the coffee maker further comprises a pressure relief assembly, wherein,

the pressure relief assembly comprises a pressure relief valve and a pressure relief spring; the pressure relief valve is connected with the pressure relief spring; the pressure relief valve is arranged inside the liquid outlet; the pressure relief valve is capable of sealing the liquid outlet;

when the pressure in the accommodation chamber reaches a preset pressure, the pressure relief valve presses against the pressure relief spring to make the liquid outlet open.

In one of the embodiments, the coffee maker further comprises an automatic powder delivery assembly or a bean grinding assembly; wherein,

the automatic powder delivery assembly or the bean grinding assembly is installed inside the shell body;

the heating assembly is a water storage boiler or an instant heating element.

The present invention further provides a control method of the coffee maker, which is applied in the coffee maker with any one of features above, and the control method comprises steps as follows:

step S100: adding coffee powder into the brewing vessel of the brewing assembly;

step S200: controlling the heating assembly, by the control assembly, to add heated water into the accommodation chamber of the brewing vessel; when quantity of the heated water reaches a preset quantity, controlling the heating assembly to stop adding heated water into the accommodation chamber;

step S300: controlling the slight pressure assembly, by the control assembly, to discharge air into the heated water in the brewing vessel and to form bubbles; the bubbles rising and bursting, which makes the heated water in the brewing vessel fully mixed with the stuff to be brewed;

step S400: controlling the chamber-top seal, by the control assembly, to seal the air outlet, and controlling the slight pressure assembly to discharge air into the accommodation chamber continuously to generate pressure, thereby extracting impure substances in the stuff to be brewed and making the heated water fully mixed with the stuff to be brewed to form mixed solution;

step S500: controlling the slight pressure assembly, by the control assembly, to apply pressure to the accommodation chamber continuously to press the mixed solution in the brewing vessel into the filtering assembly, thereby coffee liquid is filtered by the filtering assembly and is output.

The beneficial effects of the present disclosure are as follows:

According to the coffee maker and the control method of the present disclosure, the structure of the coffee maker is more simple and reasonable. When the coffee powder is added into the accommodation chamber of the brewing vessel, add heated water into the accommodation chamber through the heating assembly, so that the coffee powder is fully mixed with the heated water; then apply pressure to the accommodation chamber through the slight pressure assembly, and the impure substances in the coffee powder are extracted under slight pressure, so that the coffee powder can be fully dissolved in the heated water, thereby obtaining high quality brewed coffee liquid, and achieving improvement in concentration, temperature, flavor, and taste of the coffee liquid. The efficiency of brewing coffee is improved, and the coffee maker is convenient for users.

### BRIEF DESCRIPTION OF THE DRAWINGS

FIG. 1 is a stereogram of the coffee maker according to one embodiment of the present invention;

FIG. 2 is a stereogram of the coffee maker shown in FIG. 1 with the shell body removed;

FIG. 3 is a schematic structural view illustrating a brewing assembly, a filtering assembly and a slight pressure assembly of the coffee maker shown in FIG. 2;

FIG. 4 is an exploded view of the coffee maker shown in FIG. 1;

FIG. 5 is a schematic view illustrating the coffee maker of FIG. 1 when it is brewing coffee;

FIG. 6 is a working principle diagram of the coffee maker shown in FIG. 1;

wherein the elements are denoted as follows:
100. coffee maker;
110. shell body;
120. brewing assembly;
121. brewing vessel;
1211. powder inlet;
1212. water inlet;
1213. air outlet;
122. driving unit;
1221. motor;
1222. motor support seat;
123. transmission mechanism;
1231. gear wheel;
1232. gear rack;
1233. transmission rod;
1214. latching part;
124. stopper mechanism;
1241. travel switch;
1242. top stop lever;
125. chamber-top seal;
126. chamber-bottom seal;
127. fast clamp;
130. heating assembly;
140. slight pressure assembly;
141. booster pump;
142. pressure pipe;
150. filtering assembly;
151. filtering cup;
1511. liquid outlet;
152. filter;
153. fixing ring;
160. control assembly;
161. control panel;
162. control board;
170. pressure relief assembly;
171. pressure relief valve;
172. pressure relief spring;
173. pressure relief sealing ring;
180. bean grinding assembly;
181. bean storing assembly;
1811. bean box;
1812. bean box cover;
1813. bean detecting device;
182. bean grinding mechanical;
190. coffee cup.

### DETAILED DESCRIPTION OF THE PREFERRED EMBODIMENTS

In order to make the objective, the technical schemes and the advantages of the present disclosure clearer and more understandable, the coffee maker and the control method of the present disclosure will be described in more details with reference to the accompanying figures and preferred embodiments. It should be understood that, the embodiments described in details are only explanations for the present invention but not limitations to the present invention.

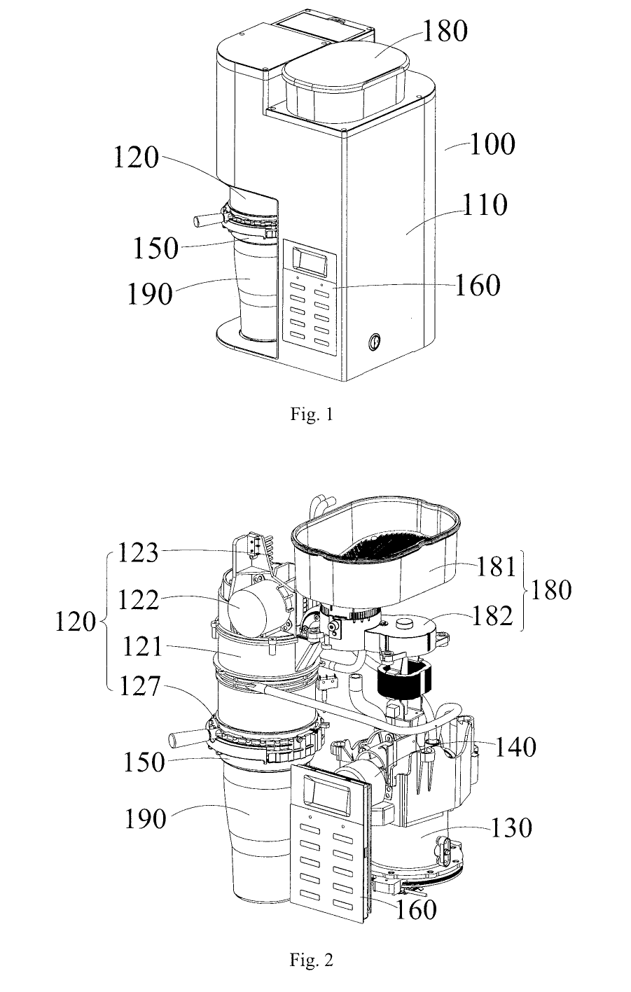

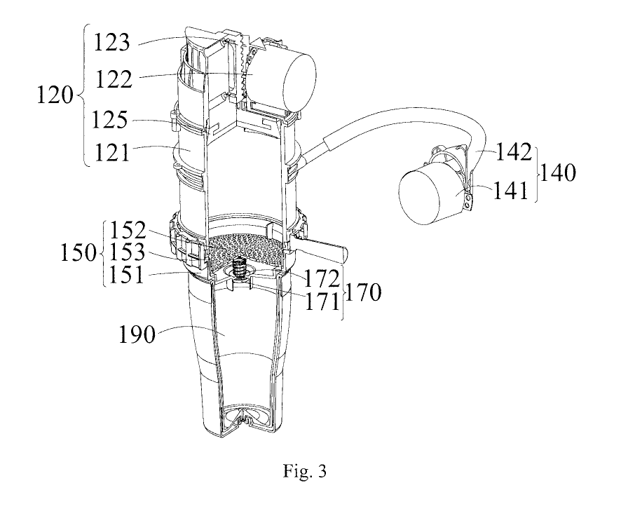

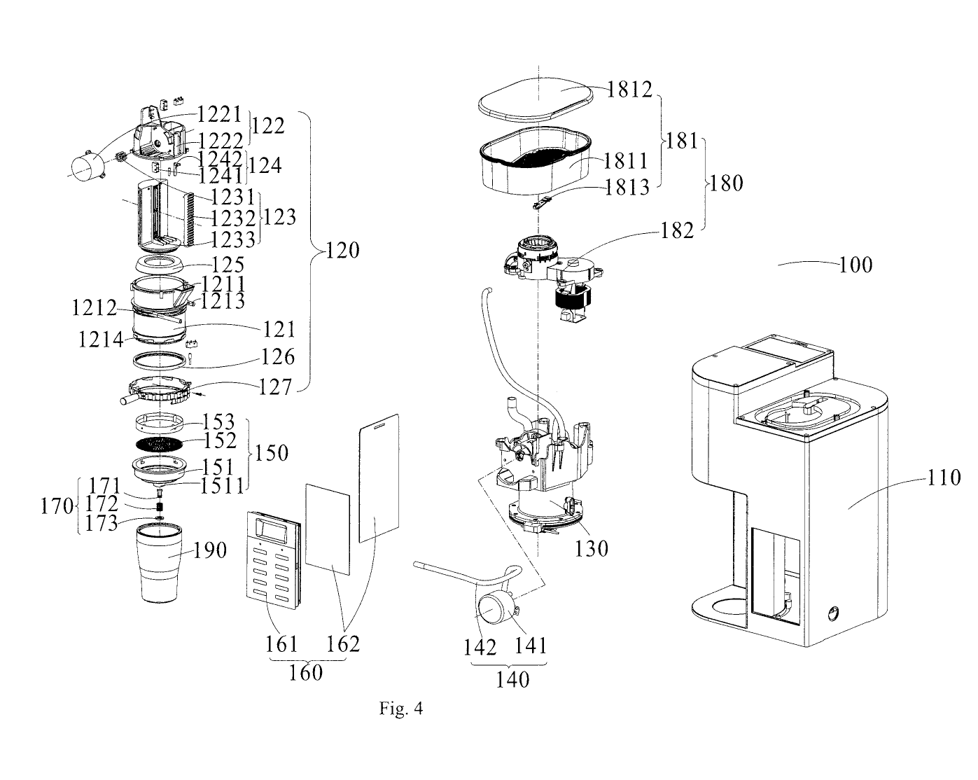

As shown in FIGS. 1-4, the present invention provides a coffee maker 100, especially, a brewing device. The coffee maker 100 is configured to brew coffee liquid. Without doubt, the coffee maker 100 of the present invention can also be used to brew mixed drinks, or soak and brew tea.

In the present invention, the coffee maker 100 comprises a shell body 110, a brewing assembly 120, a slight pressure assembly 140, a heating assembly 130 and a filtering assembly 150. The brewing assembly 120, the slight pressure assembly 140 and the heating assembly 130 are all installed in the shell body 110. The filtering assembly 150 is installed on the brewing assembly 120, and the shell body 110 performs functions of supporting and is configured to support the brewing assembly 120, the slight pressure assembly 140 and the heating assembly 130. The brewing assembly 120 is the main assembly to brew the stuff. The stuff to be brewed is coffee powder, tea or mixed drink and so on. After the stuff to be brewed is added into the brewing assembly 120, the heated water supplied by the heating assembly 130 is mixed with the stuff to be brewed to form mixed solution. The present invention will be specified taking coffee powder as an example of the stuff to be brewed. The coffee powder is mixed with heated water to form coffee liquid. The heating assembly 130 supplies heated water to the brewing assembly 120, so that the coffee powder in the brewing assembly 120 is soaked in the heated water. The slight pressure assembly 140 exerts slight pressure to the brewing assembly, so as to ensure that the coffee powder in the brewing assembly 120 can be fully extracted and that the coffee powder is mixed fully with the heated water, thereby obtaining high-quality coffee liquid. The filtering assembly 150 filters the coffee liquid, so as to filter out the impure substances and other particles in the coffee liquid and further ensure fine and favorable coffee liquid, thereby meeting demands of high quality life of users.

The brewing assembly 120 comprises a brewing vessel 121. The brewing vessel 121 is installed on the shell body 110. The brewing vessel 121 has a hollow accommodation chamber, which accommodates the stuff to be brewed (namely the coffee powder). The accommodation chamber of the brewing vessel 121 is a thorough chamber. One end of the thorough chamber is sealed by a chamber-top seal 125 of the brewing vessel 121, and the other end of the thorough chamber is sealed by the filtering assembly 150. Namely, the chamber-top seal 125 and the filtering assembly 150 ensure the tightness of the accommodation chamber of the brewing vessel 121, so that the slight pressure assembly 140 could supply slight pressure to the accommodation chamber. The other end of the thorough chamber, which is connected with the filtering assembly 150, is a liquid outlet, through which the coffee liquid in the brewing vessel 121 flows into the filtering assembly 150.

The heating assembly 130 is in communication with the accommodation chamber and is configured to the brewing vessel 121 with heated water, so that the coffee powder in the accommodation chamber can be soaked in the heated water. What's more, according to different demands of tastes, users can choose heated water with different temperature and different coffee soaking time, which is convenient for users to use. The slight pressure assembly 140 is in communication with the accommodation chamber and is configured to pressure to the brewing vessel 121, and under slight pressure, the impure substances in the coffee powder are extracted. What's more, the working sequence of the heating assembly 130 and the slight pressure assembly 140 is as follows: firstly, the heating assembly 130 supplies heated water to the brewing vessel 121 to soak the coffee powder; secondly, the slight pressure assembly 140 supplies slight pressure to the brewing vessel 121, so that the soaked coffee powder can be fully extracted and that the coffee powder can be completely dissolved in the heated water, thereby obtaining high quality brewed coffee liquid.

The filtering assembly 150 takes effects of protection and discharge. The filtering assembly 150 is installed on the lower part of the brewing vessel 121. The filtering assembly 150 is in communication with the accommodation chamber, so that the coffee liquid in the brewing vessel 121 can be filtered by the filtering assembly 150, thereby removing the impure substances and other particles in the coffee liquid and ensuring favorable taste of the coffee liquid. Moreover, the coffee liquid in the brewing vessel 121 is pressed out by the slight pressure assembly 140 or pumped out by a pump. In this embodiment, the coffee liquid in the brewing vessel 121 is pressed out by the slight pressure assembly 140. Lower end of the filtering assembly 150 has a liquid outlet 1511. When the coffee liquid is being brewed, the liquid outlet 1511 is sealed, and the slight pressure assembly 140 supplies pressure to the brewing vessel 121, so as to extract impure substances in the coffee powder. After the coffee liquid is brewed, the liquid outlet 1511 opens, and the slight pressure assembly 140 continuously supplies pressure to the brewing vessel 121. Under the slight pressure, the coffee liquid in the brewing vessel 121 goes through and is filtered by the filtering assembly 150, and flows out the liquid outlet 1511. Coffee making is convenient and fast, and the brewing speed of coffee liquid is enhanced, which is convenient for users to use.

In principle, the shape of the accommodation chamber is not limited, as long as it can be ensured that the coffee powder can be soaked by the heated water. What's more, according to different usage demands, users can choose different soaking time, so as to ensure appropriate solution of coffee powder and improve extraction effect. The coffee maker 100 of the present invention achieves intelligent and automatic brewing through exerting air pressure, and extracts impure substances in the coffee powder by supplying slight pressure uniquely, thereby obtain high quality brewed coffee liquid. The extraction effects of the present coffee maker in concentration, temperature, flavor, and taste of the coffee liquid are improved so much that the classical coffee maker and the traditional pressure coffee maker in the prior art can never achieve these effects.

At present, the coffee maker in the prior art usually adopts the following coffee making method: soak the coffee powder primarily with hot water, and then adopt the method of natural dripping to make coffee liquid. This kind of coffee maker has the problems of insufficient dissolution of coffee powder and long time of brewing coffee, which will affect usage. As for the coffee maker 100 of the present invention, after the coffee powder is added to the accommodation chamber of the brewing vessel 121, the heating assembly 130 supplies heated water to the accommodation chamber, so that the coffee powder can be mixed with the heated water fully; the slight pressure assembly 140 supplies pressure to the accommodation chamber; under slight pressure, impure substances in the coffee powder are extracted, so that the coffee powder can be dissolved in the heated water fully, thereby obtaining high quality brewed coffee liquid, and achieving improvement in concentration, temperature, flavor, and taste of the coffee liquid. The efficiency of brewing coffee is enhanced, and the coffee maker is convenient for use. The coffee maker 100 of the present invention has a simple structure, has low cost and can relief the burden on the users. What's more, the coffee maker 100 of the present invention has a simple structure, is convenient for users to use and saves time.

The coffee maker 100 further comprises a control assembly 160. The control assembly 160 comprises a control panel 161 and a control board 162. The control panel 161 is disposed on the shell body 110. The control board 162 is disposed in the shell body 110. The control board 162 is electrically connected with the control panel 161; the control board 162 is electrically connected with the brewing assembly 120; the control board 162 is electrically connected with the heating assembly 130; the control board 162 is electrically connected with the slight pressure assembly 140. Through the control assembly 160, the coffee maker 100 achieves intelligent control, thereby speeding up the intelligent process of the coffee maker and making convenience for users. Many kinds of touch keys, such as the heating temperature of the heating assembly 130, the soaking time of coffee powder, the pressure exerted by the booster pump 141 and so on, are provided on the control panel 161, and the users can make a choice according to their own demands. The coffee maker of the present invention can meet different demands of the users, and it is convenient for users to use. Control programs are stored in the control board 162 and control the heating assembly 130, the brewing assembly 120 and the slight pressure assembly 140 to operate.

In one of the embodiments, the slight pressure assembly 140 comprises a booster pump 141 and a pressure pipe 142. The booster pump 141 is connected with the pressure pipe 142. The pressure pipe 142 is in communication with the accommodation chamber. Through the pressure pipe 142, the slight pressure is transferred to the accommodation chamber of the brewing vessel 121 by the booster pump 141, thereby the coffee maker 100 realizes brewing coffee under slight pressure. The booster pump 141 is installed inside the shell body 110. The pressure pipe 142 goes through the shell body 110 and is connected to the brewing vessel 121. The pressure pipe 142 is in communication with the accommodation chamber through the top or the side wall of the brewing vessel 121. It should be specified that, when the pressure pipe 142 is in communication with the accommodation chamber through the side wall of the brewing vessel 121, the opening of the pressure pipe 142, which is disposed in the accommodation chamber, is configured to be lower than the liquid height of the coffee liquid in the accommodation chamber. So that, when the booster pump 141 supplies slight pressure to accommodation chamber, air bubbles are produced inside the coffee liquid. The air bubbles rise and burst, and have effects of stirring and mixing the coffee powder, so that the coffee powder could be mixed with the heated water fully, thereby increasing the concentration of coffee in the coffee liquid and increasing the extraction rate of the coffee powder, improving the flavor of the coffee liquid, etc.

Further, the pressure supplied by the booster pump 141 to the accommodation chamber is less than 0.4 MPa. Namely, the booster pump 141 only supplies slight pressure to the accommodation chamber of the brewing vessel 121, and the pressure less than 0.4 MPa supplied by the booster pump 141 can meet the requirements of extracting impure substances from the coffee powder, and can ensure that the coffee powder can be fully dissolved in the heated water and filtered out by the filtering assembly 150. What's more, when the pressure supplied by the booster pump 141 is larger, the requirements for the seal of the brewing vessel 121 and the quality requirements for the booster pump 141 will be higher, which will increase the product cost of the coffee maker 100 and be not convenient for users to use. Therefore, the pressure less than 0.4 MPa supplied by the fore pump 141 can meet the requirements of extraction of the coffee powder and ensure safe operation of the coffee maker 100, so as to avoid occurrence of safety accidents. Preferably, in this embodiment, the range of the pressure supplied by the booster pump 141 to the accommodation chamber is from 0.15 MPa to 0.25 MPa.

The coffee maker 100 of the present invention brews coffee liquid under light pressure. In brewing the coffee liquid mixed by heated water and coffee powder in the accommodation chamber of the brewing vessel 121, the slight pressure assembly 140 supplies slight air pressure to the coffee powder in the accommodation chamber, so as to extract the impure substances in the coffee powder and make the coffee powder be fully dissolved in the heated water, thereby enhancing the quality of the brewed coffee liquid, then press the coffee liquid out from the filtering assembly 150 under the slight air pressure.

In one of the embodiments, the brewing vessel 121 is further provided with a powder inlet 1211, a water inlet 1212 and an air outlet 1213. The powder inlet 1211, the water inlet 1212 and the air outlet 1213 are all in communication with the accommodation chamber. The coffee powder is input into the accommodation chamber of the brewing vessel 121 through the powder inlet 1211. The water inlet 1212 is in communication with the heating assembly 130, and the heated water is delivered into the accommodation chamber by the heating assembly 130 through the water inlet 1212, so as to soak the coffee powder in the brewing vessel 121. Additionally, as the accommodation chamber is sealed, in order to prevent the heated water from not being delivered into the accommodation chamber, the brewing vessel 121 is provided with the air outlet 1213, which is in communication with the accommodation chamber. When the heated water is added into the accommodation chamber from the heating assembly 130, the heated water enters into the accommodation chamber through the water inlet 1212, and simultaneously, the air in the accommodation chamber is discharged from the accommodation chamber through the air outlet 1213, so as to keep a balance of pressure in the accommodation chamber.

In one of the embodiments, the brewing assembly 120 further comprises a driving unit 122, a transmission mechanism 123 and a chamber-top seal 125. The driving unit 122 is connected with the transmission mechanism 123. The transmission mechanism 123 is provided on the chamber-top seal 125. The driving unit 122 drives the transmission mechanism 123 to move, and further, the transmission mechanism 123 drives the chamber-top seal 125 to seal the powder inlet 1211, the water inlet 1212 and the air outlet 1213. The driving unit comprises a motor 1221 and a motor support seat 1222. The motor support seat 1222 is installed on the shell body 110, and the motor 1221 is installed on the motor support seat 1222. The transmission mechanism 123 comprises a gear wheel 1231, a gear rack 1232 and a transmission rod 1233. The gear wheel 1231 is installed on the output shaft of the motor 1221, and the gear rack 1232 is installed on the transmission rod 1233. The transmission rod 1233 is installed on the chamber-top seal 125. The motor 1221 rotates to drive the gear wheel 1231 to rotate. The gear wheel 1231 is coupled to engage the gear rack 1232, and a rotary motion is converted into a linear motion through the cooperation of the gear wheel 1231 and the gear rack 1232. The gear wheel 1231 drives the gear rack 1232 to move linearly, so that the transmission rod 1233 drives the chamber-top seal 125 thereon to seal the powder inlet 1211, the water inlet 1212 and the air outlet 1213, thereby ensuring the tightness of the accommodation chamber, and ensuring that the no air leakage will occur when the slight pressure assembly 140 supplies pressure to the accommodation chamber. Additionally, the brewing assembly 120 further comprises a stopper mechanism 124, which is installed on the motor support seat 1222. The stopper mechanism 124 comprises a travel switch 1241 and a top stop lever 1242. The travel switch 1241 and a top stop lever 1242 are both installed on the motor support seat 1222. The travel switch 1241 is configured to limit travel of the linear motion of the gear rack 1232, thereby preventing overtravel of the gear rack 1232. The top stop lever 1242 ensures the sealing reliability of the chamber-top seal 125, and prevents position errors of the chamber-top seal 125, thereby avoiding bad influences on tightness.

It should be specified that, after the coffee powder is added into the brewing vessel 121, the driving unit 122 controls the transmission mechanism 123 to drive the chamber-top seal 125 to move, so as to seal the powder inlet 1211; then the heated water is delivered into the brewing vessel 121 by the heating assembly 130; when the amount of heated water in the brewing vessel 121 meets the requirements, the heating assembly 130 stops delivering heated water, and simultaneously, the slight pressure assembly 140 discharges air into the heated water; the bubbles rise and burst, thereby facilitating the coffee powder to be mixed and fully dissolved in the heated water. After that, the driving unit 122 controls the transmission mechanism 123 to drive the chamber-top seal 125 to move, so as to seal the water inlet 1212 and the air outlet 1213. At this moment, as the brewing vessel 121 is sealed, the slight pressure assembly continuously discharges air to the brewing vessel 121 to generate pressure, therefore the coffee powder can be fully extracted under the slight pressure.

Preferably, in the present invention, the air inlet, through which the pressure pipe 142 supplies air to the brewing vessel 121, can be the water inlet, through which the heating assembly 130 supplies water to the brewing vessel 121. Namely, the pressure pipe 142 is in communication with the heating assembly 130. In the process of brewing the coffee powder, the slight pressure assembly 140 exerts pressure to the heating assembly 130, so that the heated water in the heating assembly 130 is pushed into the brewing vessel 121 under the action of the slight pressure assembly 140. What's more, the heated water in the heating assembly 130 is only a dose for brewing the coffee liquid. The slight pressure assembly 140 continuous operating, and when the heated water in the heating assembly 130 is run out, the slight pressure assembly 140 discharges air into the brewing vessel 121.

Further, the brewing assembly 120 further comprises a fast clamp 127 and a chamber-bottom seal 126. The filtering assembly 150 is connected to and sealed to the brewing vessel 121 by the fast clamp 127. The end part of the brewing vessel 121 is provided with screw threads or latching parts 1214, which matches with the fast clamp 127. Align the fast clamp 127 with the screw threads or latching parts on the end part of the brewing vessel 121, push upwards or screw the fast clamp 127, so as to fix the fast clamp 127 tightly. Additionally, the chamber-bottom seal 126 is provided between the fast clamp 127 and the brewing vessel 121. After the filtering assembly 150 is installed onto the fast clamp 127, the chamber-bottom seal 126 can ensure the tightness between the filtering assembly 150 and the brewing vessel 121. Further, the chamber-top seal 125 and the chamber-bottom seal 126 are made of silica gel.

The fast clamp 127 has a handle and a clamping part, and the handle is arranged on the clamping part. The size of the clamping part is adjustable and can be adjusted by rotating the handle. The filtering assembly 150 is connected to the brewing vessel 121 through the clamping part. One part of the clamping part matches with the latching parts 1214 on the lower end part of the brewing vessel 121, and the other part of the clamping part matches with the top part of the filtering assembly 150. Rotate the handle to the preset position, so that the clamping part can clamp the filtering assembly 150 and the brewing vessel 121, thereby ensuring the tightness of the installed filtering assembly 150 and avoiding air leakage.

It should be specified that, after the coffee powder enters into the accommodation chamber of the brewing vessel 121 through the powder inlet 1211, the motor 1221 drives the gear wheel 1231 to rotate. The gear wheel 1231 drives the gear rack 1232 to drive the transmission rod 1233 and the chamber-top seal 125 thereon to seal the powder inlet 1211. Subsequently, the heating assembly 130 conveys heated water into the brewing vessel 121 through the water inlet 1212, so as to soak the coffee powder. At the same time, the air in the accommodation chamber is output through air outlet 1213. The motor 1221 continues driving the gear wheel 1232 to drive the chamber-top seal 125 to seal the water inlet 1212 and the air output 1213. At this moment, as the accommodation chamber is sealed, the slight pressure assembly 140 supplies slight pressure to the accommodation chamber through the booster pump 141, so as to extract the impure substances in the coffee powder, thereby enabling the coffee powder to be fully dissolved in the heated water.

In the process of installing the brewing assembly 120, install the motor 1221, the gear wheel 1231, the travel switch 1241 and the top stop lever 1242 on the motor support seat 1222; install the gear rack 1232 on the transmission rod 1233; install the chamber-top seal 125 on the transmission rod 1233; then install the assembled transmission rod 1233 and the chamber-top seal 125 inside the assembled motor support seat 1222; align the transmission mechanism 123 and the driving unit 122 with the top end of the accommodation chamber of the brewing vessel 121 and tightly fix them; then install and tightly fix the assembled brewing assembly 120 on the shell body 110; provide the bottom of the brewing vessel 121 with a chamber-bottom seal 126; align the fast clamp 127 with the screw threads or latching parts on the lower end of the brewing vessel 121, push upwards or screw the fast clamp 127; after the fast clamp 127 is attached, fix the fast clamp 127 on the brewing vessel 121 with pins and screws, so as to prevent falling.

In one of the embodiments, the filtering assembly 150 comprises a filter 152, a fixing ring 153 and a filtering cup 151. The filter 152 is installed in the filtering cup 151, and the fixing ring 153 is also provided in the filtering cup 151. The filtering cup 151 is installed on the brewing vessel 121 and is in communication with the accommodation chamber. The filtering cup 151 has a liquid outlet 1511, through which the coffee liquid is output. The filtering cup 151 is provided with a flange. In the process of assembling, align the flange of the filtering cup 151 with the entrance of the fast clamp 127, and the filter cup 151 clicks in the fast clamp 127 through the flange, thereby ensuring the tightness of the filtering cup 151 and avoiding air leakage in the process of brewing coffee.

In one of the embodiments, the coffee maker 100 further comprises a pressure relief assembly 170. The pressure relief assembly 170 is installed on the filtering assembly 150. The pressure relief assembly 170 comprises a pressure relief valve 171, a pressure relief sealing ring 173 and a pressure relief spring 172. The pressure relief valve 171 and the pressure relief spring 172 are both installed on the filtering cup 151. The pressure relief assembly 170 is arranged inside the liquid outlet 1511 of the filter 151. The pressure relief valve 171 is installed inside of the liquid outlet 1511 through the pressure relief spring 172. Additionally, a pressure relief sealing ring 173 is installed between the pressure relief valve 171 and the liquid outlet 1511, so as to ensure the tightness of the liquid outlet 1511 of the filter 151. The operation of the pressure relief valve 171 is controlled by the pressure in the accommodation chamber. When the pressure in the accommodation chamber is greater than the reset pressure, under the action of the pressure, the pressure relief valve 171 presses the pressure relief spring 172; at this moment, the pressure relief valve 171 doesn't seal the liquid outlet 1511. When the pressure in the accommodation chamber is less than the reset pressure, the force exerted on the pressure relief valve 171 is less than the elastic force of the pressure relief spring 172; at this moment, the pressure relief spring 172 props against the pressure relief valve 171, so that the pressure relief valve 171 seals the liquid outlet 1511.

Specifically, in the process of soaking the coffee, the pressure relief spring 172 is in a preset state, and at this moment, the pressure relief valve 171 and the pressure relief sealing ring 173 can seal the liquid outlet 1511. After soaking the coffee powder is done, the slight pressure assembly 140 continuously supplies slight pressure to the accommodation chamber, and the pressure relief spring 172 is in a compressed condition under pressure; at this moment, the pressure relief valve 171 and the pressure relief sealing ring 173 doesn't seal the liquid outlet 1511 any longer, and a pressure relief hole is formed between the liquid outlet 1511 and the pressure relief valve 171, so that the coffee liquid in the brewing vessel 121 flows into the filtering cup 151 through the filter 152 and flows out the liquid outlet 1511 through the filtering cup 151.

The pressure relief assembly 170 is arranged inside the liquid outlet 1511 of the filter 151, and the filter 152 and the fixing ring 153 are installed in the fixing cup; then align the flange of the filtering cup 151 with the entrance of the fast clamp 127; the filtering cup 151 is inserted into the fast clamp 127; the handle of the fast clamp 127 rotates by a certain angle, so that the pressure relief assembly 170 is lifted and fixed; simultaneously, the filtering cup 151 presses against the chamber-bottom seal 126, so as to seal the accommodation chamber. The soaking and the brewing of coffee powder are performed in the sealed accommodation chamber.

In one of the embodiments, the coffee maker 100 further comprises an automatic powder delivery assembly or a bean grinding assembly 180. The automatic powder delivery assembly or the bean grinding assembly 180 is installed in the shell body 110. Alternatively, as for the coffee maker 100, the coffee powder can be added into the brewing vessel 121 through the powder inlet 1211 manually. When the automatic powder delivery assembly is adopted to add the coffee powder, the automatic powder delivery assembly comprises a metering vessel and a driving motor. The metering vessel has an inlet and outlet slot. The metering vessel is arranged on the driving motor. The driving motor drives the metering vessel to rotate, so that the stuff is input and output through the inlet and outlet slot continuously. When the inlet and outlet slot faces the stuff inlet, the coffee powder is added into the brewing vessel 121.

When the bean grinding assembly 180 is adopted to add the coffee powder, the bean grinding assembly 180 comprises a bean storing assembly 181 and a bean grinding mechanical 182. The bean storing assembly 181 is provided above the bean grinding mechanical 182. The bean storing assembly 181 comprises a bean box 1811, a bean box cover 1812 and a bean detecting device 1813. The bean box 1811 has a bean outlet. The bean detecting device 1813 is arranged in the bean outlet. The bean box cover 1812 is provided on the bean box 1811. The bean detecting device 1813 can detect the quality of the brewed coffee beans in the bean box 1811, so as to improve the quality of the coffee liquid. The power outlet of the bean grinding mechanical 182 faces the powder inlet 1211 of the brewing vessel 121, and after being detected, the coffee beans are input into the bean grinding mechanical 182, and are ground and further input into the accommodation chamber.

In one of the embodiments, the heating assembly 130 is a water storage boiler or an instant heating element. In the present invention, the heating assembly 130 is the water storage boiler. the heating assembly 130 comprises a water tank, an water outlet pipe, a heating cavity, a heating pipe, a temperature controller and a safety part. The water tank is arranged inside the shell body 110. One end of the water outlet pipe is in communication with the water inlet 1212; the other end of the water outlet pipe is in communication with the water tank. The heating pipe heats the water in the water tank. The heating pipe is electrically connected with the temperature controller. The temperature controller controls the water temperature, and the safety part ensures the safety of the heating pipe when it operates, thereby increase reliability of the heating pipe.

The present invention further provides a control method of the coffee maker 100, and the method is applied in the coffee maker 100 of any one of the embodiments above. The method comprises the following steps:

Step S100: add coffee powder into the brewing vessel 121 of the brewing assembly 120;

Step S200: the control assembly 160 controls the heating assembly 130 to add heated water into the accommodation chamber of the brewing vessel 121; when the quantity of the heated water reaches the preset quantity, the control assembly 160 controls the heating assembly 130 to stop adding heated water into the accommodation chamber;

Step S300: the control assembly 160 controls the slight pressure assembly 140 to discharge air into the heated water in the brewing vessel 121 and to form bubbles; the bubbles rise and burst, which makes the heated water in the brewing vessel 121 fully mixed with the stuff to be brewed;

Step S400: the control assembly 160 controls the chamber-top seal 125 to seal the air outlet 1213, and controls the slight pressure assembly 140 to discharge air into the accommodation chamber continuously to generate pressure, thereby extracting the impure substances in the stuff to be brewed and making the heated water fully mixed with the stuff to be brewed to form mixed solution;

Step S500: the control assembly 160 controls the slight pressure assembly 140 to apply pressure to the accommodation chamber continuously to press the mixed solution in the brewing vessel 121 is pushed into the filtering assembly 150, thereby coffee liquid is filtered by the filtering assembly 150 and is output.

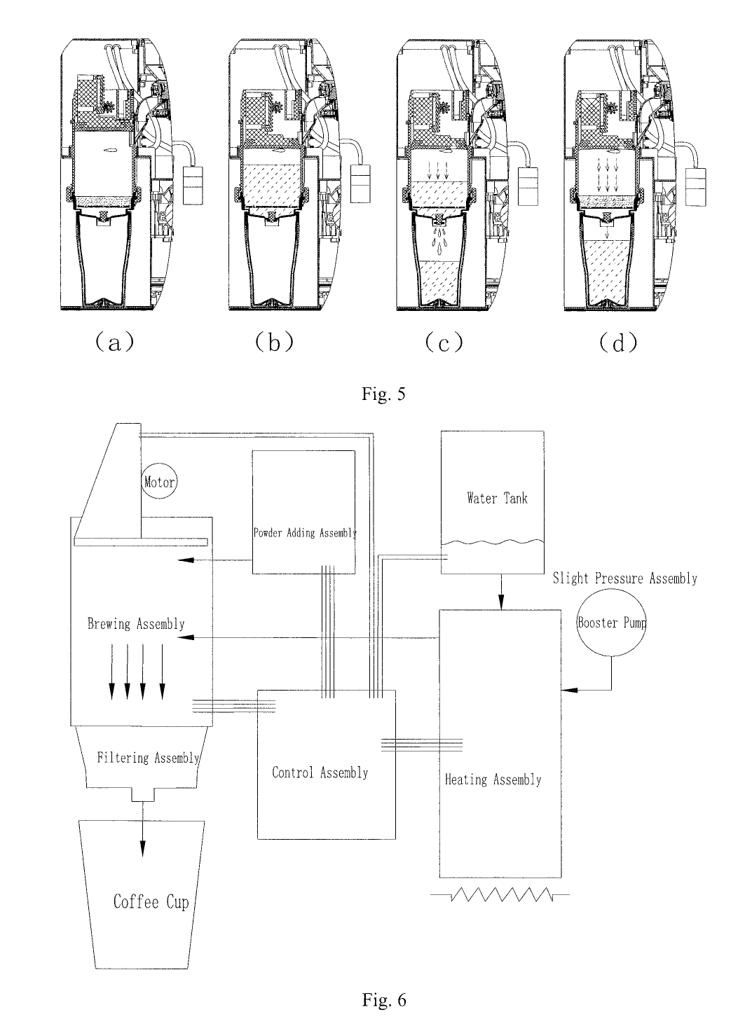

As shown in FIG. 5 and FIG. 6, the principle of the coffee maker 100 of the present invention is as follows: the control assembly 160 controls the bean grinding assembly 180 to operate; the bean grinding mechanical 182 grinds the coffee beans delivered by the bean storing assembly 181 and delivers the ground coffee beans to the powder inlet 1211 in the brewing vessel 121 of the brewing assembly 120, as shown in FIG. 5 (a); subsequently, the control assembly 160 controls the heating element of the heating assembly 130 to heat the water in the water tank, and the heated water is delivered to the water inlet 1212 of the brewing vessel 121 through the water output pipe; when the quantity of the heated water reaches the preset quantity, the control assembly 160 controls the heating assembly 130 to stop delivering heated water into the brewing vessel 121; at this moment, the coffee powder is soaked in the heated water, as show in FIG. 5 (b); subsequently, the control assembly 160 controls the gear wheel and the gear rack 1232 in the brewing assembly 120 to drive the chamber-top seal 125 to seal the powder inlet 1211, and the control assembly 160 controls the slight pressure assembly 140 to discharge air into the brewing vessel 121. The air in the heated water changes into bubbles, and the bubbles rise and burst, so as to stir the coffee powder and have it mixed with the heated water fully; subsequently, the control assembly 160 controls the gear rack 1232 and the transmission rod 1233 in the brewing assembly 120 to drive the chamber-top seal 125 to seal the water inlet 1212 and the air outlet 1213, so that the accommodation chamber is sealed; subsequently, the control assembly 160 controls the slight pressure assembly 140 to supply slight pressure to the brewing vessel 121. When the pressure is less than 0.25 MPa, the impure substances in the coffee powder are extracted, so that the coffee powder can be dissolved in the heated water fully; what's more, the assembly 160 controls the slight pressure assembly 140 to supply slight pressure to the brewing vessel 121 continuously, and when the pressure in the accommodation chamber reaches the preset pressure, the pressure relief valve 171 presses against the spring, and the pressure relief valve 171 opens; the liquid outlet 1511 of the filtering cup 150 opens, and the coffee liquid is output under the slight pressure, as shown in FIG. 5 (c); if the output of the coffee liquid is done, the control assembly 160 controls the slight pressure assembly 140 to stop operating, as shown in FIG. 5 (d). In the present invention, a coffee cup 190 can be provided to be used with the filtering cup 151, so as to receive the brewed coffee liquid. Without a doubt, other cups can be used to receive the brewed coffee liquid.

What described above are several embodiments of the present invention, and they are specific and in details, but not intended to limit the scope of the present invention. It will be understood by those skilled in the art that various modifications and improvements can be made without departing from the conception of the present disclosure, and all these modifications and improvements are within the scope of the present invention. Therefore, the scope of the present invention should be defined by the accompanying claims.

1. A coffee maker, comprising a shell body, a brewing assembly, a slight pressure assembly, a heating assembly and a filtering assembly; wherein,
the brewing assembly comprises a brewing vessel; the brewing vessel is installed on the shell body; the brewing vessel has a hollow accommodation chamber to accommodate stuff to be brewed;
the slight pressure assembly is installed in the shell body; the slight pressure assembly comprises a booster pump and a pressure pipe; the booster pump is connected with the pressure pipe, the pressure pipe is in communication with the accommodation chamber, the booster pump is configured to supply slight pressure to the brewing vessel;
the heating assembly is installed in the shell body and is in communication with the accommodation chamber, the heating assembly is configured to supply heated water to the brewing vessel;
the filtering assembly is installed on a lower part of the brewing vessel and is in communication with the accommodation chamber.

2. The coffee maker according to claim 1, further comprising a control assembly; wherein, the control assembly comprises a control panel and a control board;
the control panel is disposed on the shell body; the control board is disposed in the shell body; the control board is electrically connected with the control panel;
the control board is electrically connected with the brewing assembly; the control board is electrically connected with the heating assembly; the control board is electrically connected with the slight pressure assembly.

3. The coffee maker according to claim 2, wherein, pressure supplied to the accommodation chamber by the booster pump is less than 0.4 MPa.

4. The coffee maker according to claim 2, wherein, the brewing vessel is further provided with a powder inlet, a water inlet and an air outlet;
the water inlet is in communication with the heating assembly;
the powder inlet, the water inlet and the air outlet are all in communication with the accommodation chamber.

5. The coffee maker according to claim 4, wherein, the brewing assembly further comprises a transmission mechanism and a chamber-top seal;
the transmission mechanism is disposed on the chamber-top seal; the transmission mechanism is configured to drive the chamber-top seal to seal the powder inlet, the water inlet and the air outlet.

6. The coffee maker according to claim 5, wherein, the brewing assembly further comprises a fast clamp;
the fast clamp has a handle and a clamping part; the handle is arranged on the clamping part; the filtering assembly is connected to the brewing vessel through the clamping part; when the handle rotates to a preset position, the clamping part clamps the filtering assembly and the brewing vessel to make the filtering assembly fixed and sealed.

7. The coffee maker according to claim 6, wherein, the filtering assembly comprises a filter and a filtering cup; the filtering cup has a liquid outlet;
the filter is installed in the filtering cup; the filtering cup is installed on the brewing vessel and is in communication with the accommodation chamber.

8. The coffee maker according to claim 7, further comprising a pressure relief assembly, wherein,
the pressure relief assembly comprises a pressure relief valve and a pressure relief spring; the pressure relief valve is connected with the pressure relief spring; the pressure relief valve is installed inside the liquid outlet of the filter, the pressure relief valve is capable of sealing the liquid outlet;
when the pressure in the accommodation chamber reaches a preset pressure, the pressure relief valve presses against the pressure relief spring to make the liquid outlet open.

9. The coffee maker according to claim 1, further comprising an automatic powder delivery assembly or a bean grinding assembly; wherein,
the automatic powder delivery assembly or the bean grinding assembly is installed inside the shell body;
the heating assembly is a water storage boiler or an instant heating element.

10. A control method for the coffee maker according to claim 5, comprising steps as follows:
step S100: adding coffee powder into the brewing vessel of the brewing assembly;
step S200: controlling the heating assembly, by the control assembly, to add heated water into the accommodation chamber of the brewing vessel; when quantity of the heated water reaches a preset quantity, controlling the heating assembly to stop adding heated water into the accommodation chamber;
step S300: controlling the slight pressure assembly, by the control assembly, to discharge air into the heated water in the brewing vessel and to form bubbles; the bubbles rising and bursting, which makes the heated water in the brewing vessel fully mixed with the stuff to be brewed;
step S400: controlling the chamber-top seal, by the control assembly, to seal the air outlet, and controlling the slight pressure assembly to discharge air into the accommodation chamber continuously to generate pressure, thereby extracting impure substances in the stuff to be brewed and making the heated water fully mixed with the stuff to be brewed to form mixed solution;
step S500: controlling the slight pressure assembly, by the control assembly, to apply pressure to the accommodation chamber continuously to press the mixed solution in the brewing vessel into the filtering assembly, thereby coffee liquid is filtered by the filtering assembly and is output.

11. The coffee maker according to claim 2, further comprising an automatic powder delivery assembly or a bean grinding assembly; wherein,
the automatic powder delivery assembly or the bean grinding assembly is installed inside the shell body;
the heating assembly is a water storage boiler or an instant heating element.

12. The coffee maker according to claim 3, further comprising an automatic powder delivery assembly or a bean grinding assembly; wherein,
the automatic powder delivery assembly or the bean grinding assembly is installed inside the shell body;
the heating assembly is a water storage boiler or an instant heating element.

13. The coffee maker according to claim 4, further comprising an automatic powder delivery assembly or a bean grinding assembly; wherein,
the automatic powder delivery assembly or the bean grinding assembly is installed inside the shell body;
the heating assembly is a water storage boiler or an instant heating element.

14. The coffee maker according to claim 5, further comprising an automatic powder delivery assembly or a bean grinding assembly; wherein,
the automatic powder delivery assembly or the bean grinding assembly is installed inside the shell body;
the heating assembly is a water storage boiler or an instant heating element.

15. The coffee maker according to claim 6, further comprising an automatic powder delivery assembly or a bean grinding assembly; wherein,
the automatic powder delivery assembly or the bean grinding assembly is installed inside the shell body;
the heating assembly is a water storage boiler or an instant heating element.

16. The coffee maker according to claim 7, further comprising an automatic powder delivery assembly or a bean grinding assembly; wherein,
the automatic powder delivery assembly or the bean grinding assembly is installed inside the shell body;
the heating assembly is a water storage boiler or an instant heating element.

17. The coffee maker according to claim 8, further comprising an automatic powder delivery assembly or a bean grinding assembly; wherein,
the automatic powder delivery assembly or the bean grinding assembly is installed inside the shell body;
the heating assembly is a water storage boiler or an instant heating element.

18. The control method according to claim 10, wherein, the brewing assembly further comprises a fast clamp;
the fast clamp has a handle and a clamping part; the handle is arranged on the clamping part; the filtering assembly is connected to the brewing vessel through the clamping part; when the handle rotates to a preset position, the clamping part clamps the filtering assembly and the brewing vessel to make the filtering assembly fixed and sealed.

19. The control method according to claim 18, the filtering assembly comprises a filter and a filtering cup; the filtering cup has a liquid outlet;
the filter is installed in the filtering cup; the filtering cup is installed on the brewing vessel and is in communication with the accommodation chamber.

20. The control method according to claim 19, wherein the coffer maker further comprises a pressure relief assembly, wherein,
the pressure relief assembly comprises a pressure relief valve and a pressure relief spring; the pressure relief valve is connected with the pressure relief spring; the pressure relief valve is installed inside the liquid outlet of the filter, the pressure relief valve is capable of sealing the liquid outlet;
when the pressure in the accommodation chamber reaches a preset pressure, the pressure relief valve presses against the pressure relief spring to make the liquid outlet open.
